(19) United States
(12) Patent Application Publication
(10) Pub. No.: US 2014/0258734 A1
(43) Pub. Date: Sep. 11, 2014

(54) DATA SECURITY METHOD AND ELECTRONIC DEVICE IMPLEMENTING THE SAME

(71) Applicant: Samsung Electronics Co., Ltd., Suwon-si (KR)

(72) Inventor: Jungyoon KIM, Seoul (KR)

(73) Assignee: Samsung Electronics Co., Ltd., Suwon-si (KR)

(21) Appl. No.: 14/191,881

(22) Filed: Feb. 27, 2014

(30) Foreign Application Priority Data
Mar. 8, 2013 (KR) 10-2013-0025299

(51) Int. Cl. G06F 21/60

(52) U.S. Cl. CPC G06F 21/60
USPC 713/190

(57) ABSTRACT

A method and an apparatus that may safely secure data in an electronic device including a computing resource, that is, software (for example, an operating system) and hardware (for example, a memory and a Central Processing Unit (CPU)) for operating the electronic device are provided. The method includes receiving a request for an application key from a data generation application or a proxy application that executes encryption of data in place of the data generation application, generating an application key using an application Identification (ID) corresponding to the data generation application and a security key stored in a secure area of the electronic device, in response to the request, and encrypting data using the generated application key.

### CROSS-REFERENCE TO RELATED APPLICATION(S)

This application claims the benefit under 35 U.S.C. §119(a) of a Korean patent application filed on Mar. 8, 2013 in the Korean Intellectual Property Office and assigned Serial number 10-2013-0025299, the entire disclosure of which is hereby incorporated by reference.

### TECHNICAL FIELD

The present disclosure relates to a data security method and an electronic device. More particularly, the present disclosure relates to a method and an apparatus that may safely secure data in an electronic device including a computing resource, that is, software (for example, an operating system) and hardware (for example, a memory, a Central Processing Unit (CPU), and the like) for operating an electronic device.

### BACKGROUND

Generally, cryptography may be utilized to safely secure data. For example, data is encrypted and an authentication code is generated for preventing falsification and thus, the data may be secured. Cryptography uses an encryption key. For example, a key is used as an input value for the encryption of data and the generation of an authentication code.

An electronic device having applications may encrypt data of all of the applications with one key. However, all of the data processed in the electronic device may be vulnerable in security since they are encrypted with one identical key. More particularly, applications may read and modulate data of one another without permission.

To strengthen the security, a key may be different for each application. For example, an apparatus may separately generate and store a key for each application, and may read and use the same key when needed. In this instance, however, there is a drawback in that a storage space increases in proportion to a number of applications.

The electronic device may receive an input value from a user and may generate a different key for each application. In this instance, a user needs to input a value and thus, this may be inconvenient for the user.

In addition, the electronic device may receive a key or a certain value from a server or another device through a network, and may use the same key or value as a key of an application or for generating a key. In this instance, at least one of convenience, performance, and security may be damaged during a communication process.

Therefore, a need exists for a method and an electronic device that may safely, conveniently, and effectively, generate a key.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an electronic device that may safely, conveniently, and effectively, generate a key.

In accordance with an aspect of the present disclosure, a data security method is provided. The method includes receiving a request for an application key from a data generation application or a proxy application that executes encryption of data in place of the data generation application, generating the application key using an application Identification (ID) corresponding to the data generation application and a security key stored in a secure area of the electronic device, in response to the request, and encrypting data using the generated application key.

In accordance with another aspect of the present disclosure, a method of operating an electronic device is provided. The method includes receiving a request for an encryption key or a decryption key from an application, generating the encryption key or the decryption key using a security key stored in a secure area of the electronic device, in response to the request, and transmitting the generated encryption key or decryption key to the application.

In accordance with another aspect of the present disclosure, an electronic device is provided. The electronic device includes a user input unit, a memory including a normal area and a secure area, and a processor configured to access the normal area to execute a program of the normal area, to access the secure area to execute a program of the secure area, and to connect the user input unit and the memory, wherein the secure area includes a key generation module configured to receive a request for an application key from an application, to generate the application key using an application ID and a security key, in response to the request, and to transfer the generated application key to the application, and wherein the security key is accessible in the secure area and inaccessible in the normal area.

In accordance with another aspect of the present disclosure, an electronic device is provided. The electronic device includes a user input unit, a memory including a normal area and a secure area, and a processor configured to access the normal area to execute a program of the normal area, to access the secure area to execute a program of the secure area, and to connect the user input unit and the memory, wherein the secure area includes a key generation module configured to receive a request for an encryption key or a decryption key from an application, to generate the encryption key or the decryption key using a security key in response to the request, and to transfer the generated encryption key or decryption key to the application, and wherein the security key is accessible in the secure area and inaccessible in the normal area.

According to a data security method and an electronic device of the present disclosure, a method and an electronic device that may safely, conveniently, and effectively generate a key is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a portable terminal according to an embodiment of the present disclosure;

FIG. 2 is a block diagram of a data security device according to an embodiment of the present disclosure;

FIG. 3 is a block diagram of a data security device according to an embodiment of the present disclosure;

FIG. 4 is a flowchart illustrating a data security method according to an embodiment of the present disclosure; and

FIG. 5 is a flowchart illustrating a data security method according to an embodiment of the present disclosure.

Throughout the drawings, it should be noted that like reference numbers are used to depict the same or similar elements, features, and structures

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In embodiments of the present disclosure, an electronic device refers to a device including applications, for example, a smart phone, a tablet Personal Computer (PC), a notebook PC, a digital camera, a computer monitor, a Personal Digital Assistant (PDA), an electronic scheduler, a desktop PC, a Portable Multimedia Player (PMP), a media player (for example, a Motion Pictures Expert Group (MPEG-1 or MPEG-2) Audio Layer 3 (MP3) player), a sound system, a wrist watch, a game terminal, an electrical appliance (for example, a refrigerator, a TeleVision (TV), a washing machine), and the like.

The electronic device according to embodiments of the present disclosure may include a hardware-based secure area (secure world). Hardware (for example, a memory) may be physically or logically divided into a plurality of areas, and one of the areas may correspond to a secure area. In addition, the secure area is configured to include an operating system to which a security technology is applied, and hardware and software controlled by the operating system. The secure area may be safe from an attack, such as a memory dump, modulation, and the like. An input value for generating an application key may exist in the secure area or may be accessible in the secure area. In embodiments of the present disclosure, the application key may be used as an encryption key for encrypting data or a decryption key for decrypting data. In addition, the application key may be a symmetric key. Here, the symmetric key indicates that a key used for encrypting data is identical to a key used for decrypting data.

The electronic device according to embodiments of the present disclosure may include a security key encryption module. The security key encryption module executes encryption of a security key, and may exist in a secure area. Due to the characteristic of the secure area, the security key encryption module may not be modulated.

The electronic device according to embodiments of the present disclosure may include a key generation and data encryption/decryption module. The key generation and data encryption/decryption module may execute key generation and data encryption/decryption, and may exist in a secure area. Due to the characteristic of the secure area, the key generation and data encryption/decryption module may not be modulated. The key generation and data encryption/decryption module may be embodied separately as a key generation module and a data encryption/decryption module. In addition, the key generation and data encryption/decryption module may be embodied separately as a key generation module, a data encryption module, and a data decryption module. The separation or coupling of the fine modules may be selected based on a developer's convenience. The key generation module may exist in the secure area, and the data encryption/decryption module may exist in a normal area. Here, the normal area may be one of the areas of hardware. In addition, the normal area may be configured to include a general operating system (for example, Android, Linux, Window, and the like), and hardware and software that operate based on the operating system.

The electronic device according to embodiments of the present disclosure may include a common area (for example, a shared area (for example, a shared memory). For example, the shared area may be utilized as a path for data transmission and reception between the secure area and the normal area.

Hereinafter, a data security method and an electronic device according to embodiments of the present disclosure will be described. The terms or words used in the following descriptions should not be limited to a meaning generally understood or defined in dictionaries, and should be construed as a meaning and a concept corresponding to the technical idea of the present disclosure. Therefore, the following descriptions and enclosed drawings are merely various embodiments of the present disclosure, and may not represent the entire technical idea of the present disclosure and thus, there may exist various equivalents and modified examples as substitutes from a perspective of the present application. In addition, a few component elements in the attached drawings may be illustrated to be exaggerated or omitted, or may be schematically illustrated, and a size of each component element may not completely reflect an actual size. Therefore, embodiments of the present disclosure may not be limited by a relative size or interval drawn in the attached drawings. A description of known functions or configurations associated with the present disclosure will be omitted when it may make the subject matter of the present disclosure rather unclear.

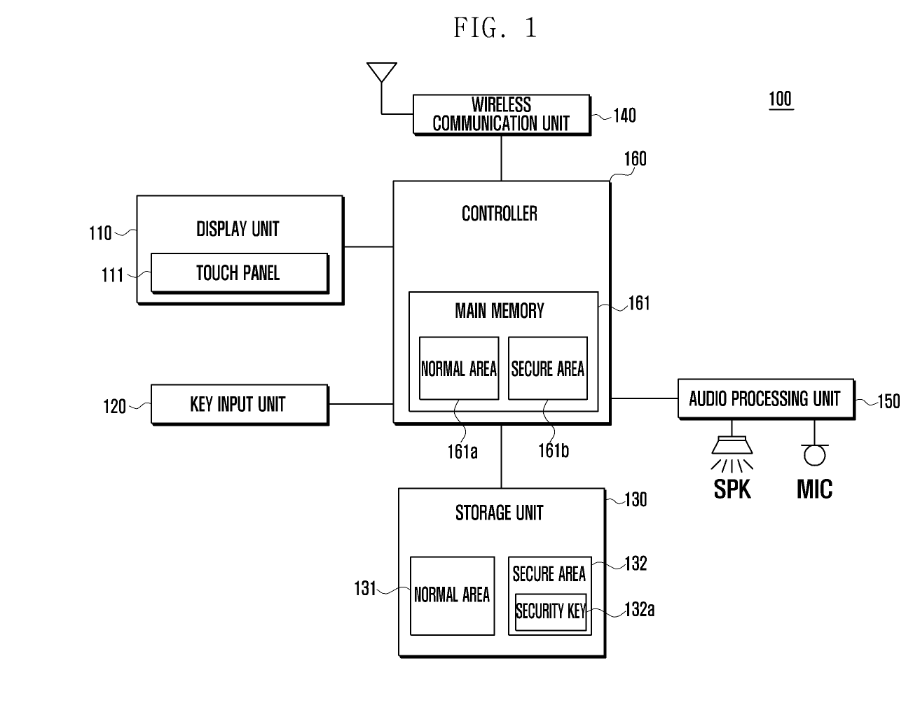

FIG. 1 is a block diagram of a portable terminal according to an embodiment of the present disclosure.

Referring to FIG. 1, a portable terminal 100 may include a display unit 110, a key input unit 120, a storage unit 130, a wireless communication unit 140, an audio processing unit 150, a Speaker (SPK), a Microphone (MIC), and a controller 160.

The display unit 110 displays data on a screen under a control of the controller 160. For example, when the controller 160 processes (for example, decoding) data and stores the processed data in a buffer, the display unit 110 converts the data stored in the buffer into an analog signal, and displays the same. When power is supplied to the display unit 110, the display unit 110 displays a lock image on the screen. When unlocking information is detected while the lock image is displayed, the controller 160 executes unlocking of the screen. The display unit 110 displays, for example, a home image, instead of the lock image under a control of the controller 160. The home image includes a background image (for example, a picture set by a user) and a plurality of icons displayed on the background image. Here, each icon indicates an application or a content (for example, a picture file, a video file, a recording, a document, a message, and the like). When one of the icons, for example, an icon of a memo application, is touched by a touch input instrument, the display unit 110 displays a memo pad under a control of the controller 160.

The display unit 110 may be formed of a Liquid Crystal Display (LCD), an Active Matrix Organic Light Emitted Diode (AMOLED), a flexible display, a transparent display, and the like.

The display unit 110 may be a touch panel 111, which is an example of a user input unit, and corresponds to a touch screen installed on the screen of the display unit 110. More particularly, the touch panel 111 may be embodied as an add-on type indicating that a touch panel is positioned on the screen of the display unit 110, or as an on-cell type or in-cell type indicating that a touch panel is inserted into the display unit 110.

The touch panel 111 generates a touch event in response to a user gesture with respect to the screen, executes Analog-to-Digital (AD) conversion on the touch event, and transfers the converted touch event to the controller 160. Here, the touch event includes one or more touch coordinates (x, y). For example, a touch Integrated Circuit (IC) of the touch panel 111 detects a touch of a user, determines a touch area in response to the touch, and transfers touch coordinates (x, y) included in the touch area to the controller 160. The touch panel 111 may be configured to include a hand touch panel that detects a hand gesture and a pen touch panel that detects a pen gesture. Here, the hand touch panel is embodied as a capacitive type. The hand touch panel may also be embodied as a resistive type, an infrared type, or an ultrasonic type. In addition, the hand touch panel may not always generate a touch event by a hand gesture, and may generate a touch event by another object (for example, an object of a conductive material that may give a change in capacitance). The pen touch panel may be formed as an electromagnetic induction type. Therefore, the pen touch panel may generate a touch event by a touch pen that is specially designed to form a magnetic field.

The key input unit 120 is another example of the user input unit, and generates a key event associated with user settings and controlling a function of the portable terminal 100, and transfers the generated key event to the controller 160. The key event may include a power on/off event, a volume adjusting event, a screen on/off event, a shutter event, and the like. The controller 160 may control the components in response to a key event.

The storage unit (secondary memory unit) 130 may be a disk, a Random-Access Memory (RAM), a Read-Only Memory (ROM), a flash memory, or the like. More particularly, the storage unit 130 may be formed of a normal area 131 and a secure area 132. The normal area 131 may be designed to be physically separated from the secure area 132. The secure area 132 may be utilized as an area that is inaccessible by an operating system or applications of the normal area 131. The normal area 131 may be an opposite concept of the secure area 132, and may be referred to as a non-secure area. The normal area 131 in which a main operating system of a corresponding terminal and applications operating based on the main operating system are installed and thus, may be referred to as a main area. Therefore, relatively, the secure area 132 may be referred to as a sub-area. Hereinafter, for ease of description, the terms, ‘normal’, ‘main’, and ‘non-secure’, will be commonly called as ‘normal’. In addition, the terms, ‘secure’ and ‘sub’, will be commonly called as ‘secure’.

The normal area 131 may be formed of a normal program area and a normal data area. The normal program area may store a boot program, a normal operating system, and one or more applications (hereinafter referred to as normal applications) that may operate based on the normal operating system. The applications in the normal area 131 may be classified into an embedded application and a 3^{rd} party application. For example, the embedded application may be a web browser, an e-mail program, an instant messenger, and the like. When power of a battery is supplied to the portable terminal 100, the boot program is loaded in a main memory unit of the controller 160. The boot program may load the normal operating system in the main memory unit. For example, Android, Window, iOS, or the like may be applied as the normal operating system of the present disclosure. The normal data area may store data generated by the normal operating system and the normal application, data used for executing the normal operating system and the normal application, and data received from an external device (for example, a server, a desktop PC, a tablet PC, and the like) through the wireless communication unit 140.

The secure area 132 may be formed of a security program area and a security data area. The secure area 132, particularly, the security data area, may be inaccessible by the normal operating system or the normal applications. The security program area may store a security operating system, one or more applications (hereinafter referred to as security applications) that may operate based on the security operating system, and an operating system monitor. For example, Mobicore of G&D (Giesecke & Devrient) may be applied as the security operating system of the present disclosure. The security operating system may be loaded in the main memory under a control of the normal operating system. Alternatively, the security operating system may be loaded in the main memory by the boot program. Mobicore may be a security product that may enable a portable terminal to safely execute Internet banking, electronic payment, and the like. The security applications may be classified into an embedded application and a 3^{rd} party application. The operating system monitor may act as an interface between the normal operating system and the security operating system. For example, TrustZone technology of ARM (Advance RISC Machine) may be applied as the operating system monitor of the present disclosure. The security data area may store data generated by the security operating system and the security application, data used for executing the security operating system and the security application, and data received by the security operating system and the security application from an external device from the wireless communication unit 140. For ease of description, hereinafter, the data of the normal data area is referred to as ‘normal data’ and the data of the security data area is referred to as ‘security data’.

The security data is accessible in the security operating system, the security application, and the operating system monitor, and is inaccessible in the normal area 131. For example, the normal operating system or the application in the normal area 131 may not directly access the security data, and may access the security data through the operating system monitor. Therefore, the security data may be safely secured from an unauthorized entity (for example, a hacking program).

The security data (for example, a unique value of the corresponding portable terminal 100) may be used as an input value for generating an application key. The security data that is used as an input value may be referred to as a security key 132a, a protected device key, a device unique key, or the like.

The storage unit 130 may store a security key encryption module.

The input value (that is, the security key 132a) may not be obtained or inferred from a new value (that is, a value output from an encryption module) generated by the security key encryption module. Therefore, a cryptographic permutation algorithm that encrypts a single input value and outputs the encrypted value may be applied to the security key encryption module. In addition, a hash function, for example, a Message Digest algorithm 5 (MD5) may be applied to the security key encryption module, together with the cryptographic permutation algorithm.

The security key encryption module may be stored in the secure area 132. For example, the security key encryption module may be a security application that operates based on the security operating system. Then, the security key encryption module may have an access right for security data, particularly, the security key 132a. The security key encryption module may be stored in the normal area 131. For example, the security key encryption module may be an application that operates based on the normal operating system. In this case, the security key encryption module may request the security key 132a from the security operating system through the operating system monitor. The security operating system may determine whether the security key encryption module is an authorized entity. When the security key encryption module is determined to be the authorized entity, the security operating system may transfer the security key 132a to the security key encryption module.

The storage unit 130 may store an application symmetric key generation module (hereinafter, a key generation module).

The key generation module may receive a request message for requesting an application key from the authorized entity. Here, the authorized entity may be an application that generates data. The application may be configured to include a routine that encrypts data using an application key, and decrypts encrypted data using an application key. The encryption/decryption routine may be executed in separate encryption/decryption applications. For example, the data generation application may request encryption or decryption of data from an encryption/decryption application.

The key generation module may request an ‘encrypted security key’ from the security key encryption module, in response to the request message received from the authorized entity. In addition, the key generation module may calculate an application Identification (ID) corresponding to a data generation application through an operation process (or may determine an ID through accessing a memory), in response to the request message received from the authorized entity. The application ID may be a unique value for each application.

The application ID may be obtained to be identical for each calculation. In addition, the application ID may be obtained to be identical for each time, although a corresponding application is updated. An input value that enables an application ID identical to an application ID that is used before the application is updated to be obtained, that is, a seed value, may be provided. For example, when the application ID used before update is F(“STRING”), “STRING” may be provided as a seed value after update so that F(“STRING”) may be obtained. Here, F( ) is a certain function. For example, the function may be a hash function.

The application ID may correspond to, for example, a full path of a corresponding application (for example, C:\Program files\Office), a name of a corresponding application, a public key certificate of an author of a corresponding application, and the like. In addition, the application ID may be calculated by the following operations. The following operations may not limit the technical idea of the present disclosure.

(1) Application ID=F (full path [symbol] name [symbol] certificate)

(2) Application ID=F (full path name certificate)

For example, the function may be a hash function. [symbol] and [symbol] denote operations, which may be identical or different. Examples of [symbol] and [symbol] may include an XOR operation, a concatenation operation, and the like.

The key generation module may generate an application key using the security key 132a (or a security key encrypted by the encryption module) and the application ID, and may transfer the generated application key to an entity that requests the application key. Here, a cryptographic function may be applied to generation of the application key. The cryptographic function may generate a new value from two input values and output the generated value. Here, one of the two input values may be the security key 132a or a security key encrypted by the security key encryption module. The other input value may be an application ID. As the cryptographic function, for example, Secure Hash Algorithm 256 (SHA-256), an Advanced Encryption Standard 128 (AES-128), and the like may be applied.

The described cryptographic permutation algorithm may be applied to the generation of the application key. For example, the key generation module combines the security key 132a and the application ID into a single input value, and may encrypt the combined input value so as to generate the application key.

The key generation module may be one of the components of the secure area 132. For example, the key generation module may be a security application that operates based on the security operating system. Thereafter, the key generation module may have an access right for security data, particularly, the security key 132a. The key generation module may be one of the components of the normal area 131. For example, the key generation module may be an application that operates based on the normal operating system. In this case, the key generation module may request the security key 132a from the security operating system through the operating system monitor. The security operating system may determine whether the key generation module is an authorized entity. When the key generation module is determined to be the authorized entity, the security operating system may transfer the security key 132a to a key generation encryption module.

The wireless communication unit 140 executes a voice call, a video call, or data communication with an external device through a network, under a control of the controller 160. The wireless communication unit 140 includes a wireless frequency transmitter that up-converts and amplifies a frequency of a transmitted signal and a wireless frequency receiver that low-noise amplifies and down-converts a frequency of a received signal. In addition, the wireless communication unit 140 includes a mobile communication module (for example, a 3^{rd}-Generation (3G) mobile communication module, a 3.5G mobile communication module, a 4G mobile communication module or the like), a digital broadcasting module (for example, a DMB module), and a short distance communication module (for example, a Wi-Fi module, a Bluetooth module, and an Near Field Communication (NFC) module).

The audio processing unit 150 executes input and output of an audio signal (for example, voice data) for voice recognition, voice recording, digital recording, and calling by coupling with a SPK and MIC. The audio processing unit 150 receives an audio signal from the controller 160, Digital-to-Analog (DA) converts the received audio signal into an analog signal, amplifies the analog signal, and outputs the amplified signal to the SPK. The audio processing unit 150 Analog-to-Digital (AD) converts an audio signal received from the MIC into a digital signal, and provides the digital signal to the controller 160. The SPK converts the audio signal received from the audio processing unit 150 into a sound wave, and outputs the sound wave. The MIC converts a sound wave transferred from a person or other sound sources into an audio signal.

The controller 160 controls general operations of the portable terminal 100 and a signal flow between internal components of the portable terminal 100, executes a function of processing data, and controls supplying of power from a battery to the components.

The controller 160 may be formed of one or more Central Processing Units (CPUs). A CPU is a fundamental control unit of a computer system that carries out operation and comparison of materials, interpretation and implementation of an instruction, and the like. The CPU includes various registers that temporarily store data or an instruction. The controller 160 may be formed of one or more Graphical Processing Units (GPUs). A GPU is a graphical control unit that carries out operation and comparison of materials associated with a graphics, interpretation and implementation of an instruction, and the like, in place of a CPU. For each of the CPU and the GPU, two or more independent cores (for example, a quad-core) are integrated into a single package formed of a single integrated circuit. For example, CPUs may be integrated into a single multi-core processor. Moreover, a plurality of GPUs may be integrated into a single multi-core processor. In addition, a CPU and a GPU may be integrated into a single chip (i.e., System on Chip (SoC)), and the CPU and the GPU may correspond to a package of a multi-layer. A configuration including a CPU and a GPU may be referred to as an Application Processor (AP). In the controller 160, at least one of the CPUs may be a CPU in a secure area, at least one of the GPUs may be a GPU in a secure area, and at least one of the APs may be an AP in a secure area.

The controller 160 may be configured to further include a main memory unit 161, for example, a RAM. For example, the CPU, the GPU, the AP, and the like of the controller 160 may access the main memory unit 161 to read various programs and data loaded in the main memory unit 161, may interpret an instruction of the read program, and may execute a function associated with the read result. The main memory unit 161 stores various programs loaded from the storage unit 130, for example, a boot program, an operating system, an operating system monitor, and applications. More particularly, the main memory unit 161 may be formed of a normal area 161a and a secure area 161b, to correspond to the storage unit 130. For example, to the normal area 161a of the main memory unit 161, a boot program, a normal operating system, a normal application, and normal data may be loaded. To the secure area 161b of the main memory unit 161, a security operating system, a security application, and security data may be loaded.

With the tendency of digital devices for convergence, there are too many various modifications of a digital device to enumerate. The portable terminal 100 may further include components that are not mentioned above, such as a camera, an acceleration sensor, a Global Positioning System (GPS) module, a vibration motor, an accessory, an ear jack, and the like. Here, the accessory may be a component of the portable terminal 100, which may be detachable from the portable terminal 100, for example, a touch pen, and the like.

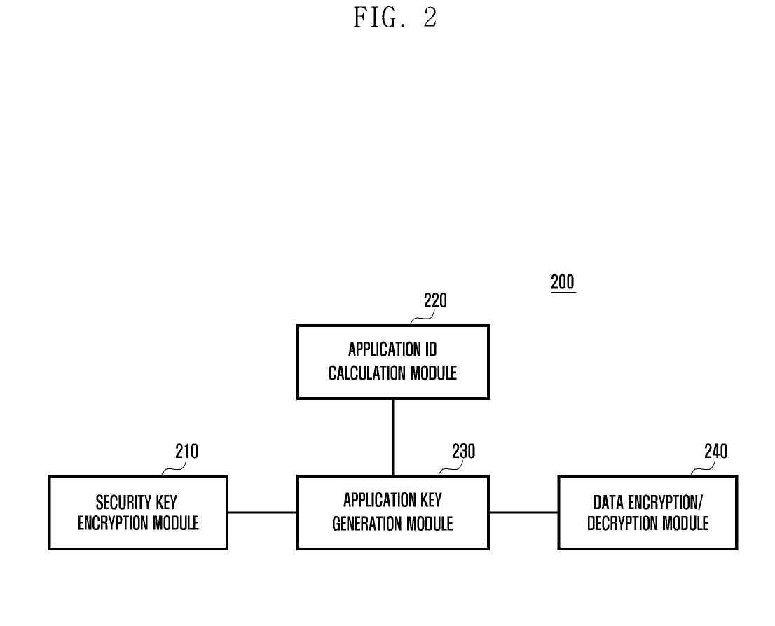

FIG. 2 is a block diagram of a data security device according to an embodiment of the present disclosure.

Referring to FIG. 2, a data security device 200 may include a security key encryption module 210, an application ID calculation module 220, an application key generation module 230, and a data encryption/decryption module 240. The security key encryption module 210 encrypts a security key 132a and transfers the encrypted security key to the application key generation module 230. The application ID calculation module 220 calculates an application ID, and transfers the calculated application ID to the application key generation module 230. The application key generation module 230 may receive a request message for requesting an application key from the data encryption/decryption module 240. In response to the request message, the application key generation module 230 requests the application ID calculation module 220 to obtain an application ID. In addition, in response to the request message, the application key generation module 230 requests the security key encryption module 210 to encrypt the security key 132a. The application key generation module 230 receives the encrypted security key and the application ID from the security key encryption module 210 and the application ID calculation module 220, respectively, generates an application key using the same, and transfers the application key to the data encryption/decryption module 240. The data encryption/decryption module 240 may encrypt or decrypt data of a corresponding application using the application key.

The data security device 200 may be a part of the portable terminal 100. More particularly, the security key encryption module 210, the application ID calculation module 220, the application key generation module 230, and the data encryption/decryption module 240 may be modules stored in the main memory unit 161 of the controller 160. Accordingly, the controller 160, for example, the AP, the CPU, or the like may access the main memory unit 161 and may operate the security key encryption module 210, the application ID calculation module 220, the application key generation module 230, and the data encryption/decryption module 240. At least one of the components may be a component of a secure area 161b of a main memory unit 161. The data encryption/decryption module 240 may be an authorized entity, and may be an application that generates data. The data generation application may be one of the components of a normal area. The data generation application may be one of the components of a secure area. In addition, the data encryption/decryption module 240 may be a separate proxy application that encrypts/decrypts data in place of the data generation application. The proxy application may be a component of the secure area or the normal area.

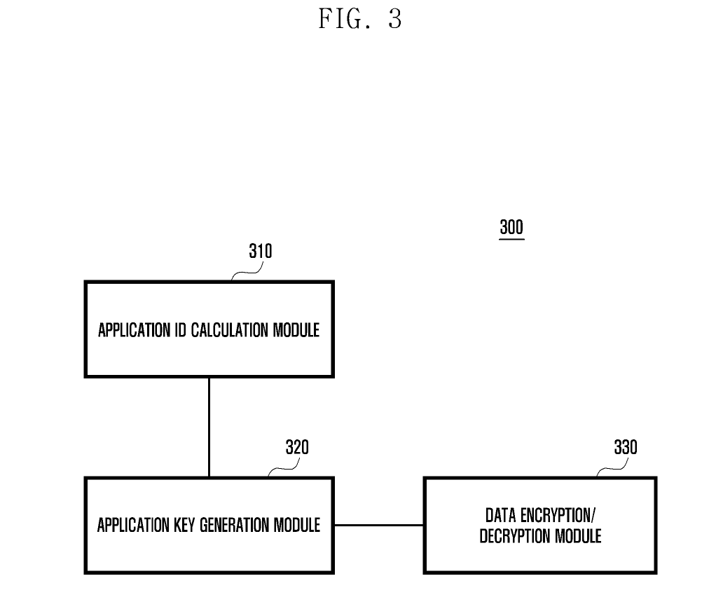

FIG. 3 is a block diagram of a data security device according to an embodiment of the present disclosure.

Referring to FIG. 3, a data security device 300 may include an application ID calculation module 310, an application key generation module 320, and a data encryption/decryption module 330. The application ID calculation module 310 calculates an application ID and transfers the calculated application ID to the application key generation module 320. The application key generation module 320 may receive a request message for requesting an application key, from the data encryption/decryption module 330. In response to the request message, the application key generation module 320 requests the application ID calculation module 310 to obtain an application ID. The application key generation module 320 may obtain the security key 132a in the secure area 132. The application key generation module 320 receives the application ID from the application ID calculation module 310, and combines the security key 132a and the application ID as a single input value. The application key generation module 320 generates an application key using the combined input value, and transfers the application key to the data encryption/decryption module 330. The data encryption/decryption module 330 may encrypt or decrypt data of a corresponding application using the application key.

The data security device 300 may be a part of the portable terminal 100. More particularly, the application ID calculation module 310, the application key generation module 320, and the data encryption/decryption module 330 may be modules stored in the main memory unit 161 of the controller 160. Accordingly, the controller 160, for example, the AP, the CPU, or the like may access the main memory unit 161 and may operate the application ID calculation module 310, the application key generation module 320, and the data encryption/decryption module 330. At least one of the components may be a component of the secure area 161b of the main memory unit 161. The data encryption/decryption module 330 may be an authorized entity, and may be an application that generates data. In addition, the data encryption/decryption module 330 may be a proxy application that encrypts/decrypts data in place of the data generation application.

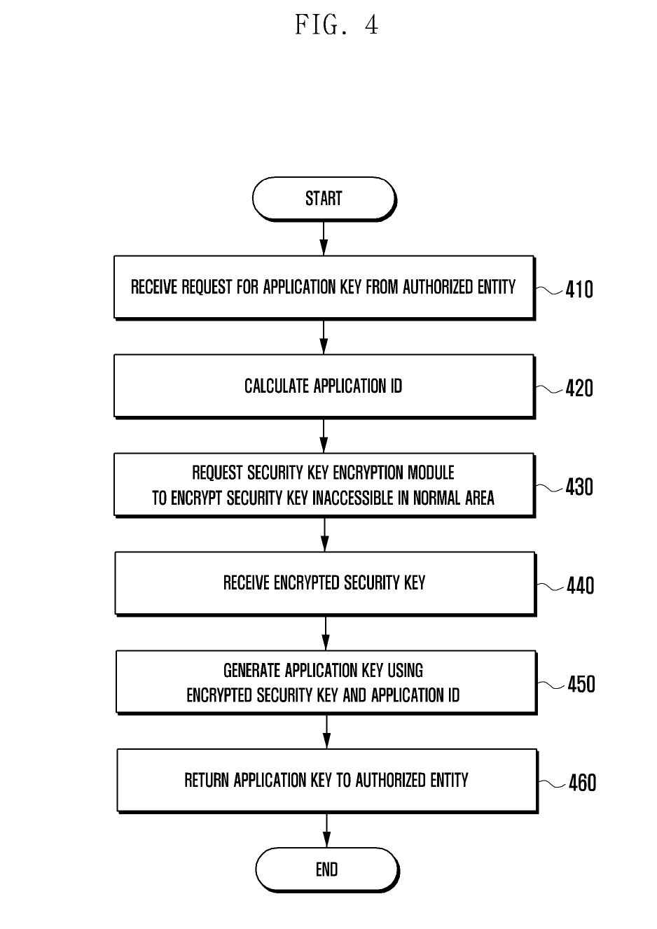

FIG. 4 is a flowchart illustrating a data security method according to an embodiment of the present disclosure.

Referring to FIGS. 1, 2, and 4, an authorized entity may generate data. Here, the authorized entity may be various applications that are installed in the portable terminal 100 and generate data (for example, a camera application, a Social Network Service (SNS) application, an instant messenger, an alarm application, a calculator, and the like). The authorized entity may include the data encryption/decryption module 240. The data encryption/decryption module 240 may be a separate application. When data is generated or decryption of encrypted data is needed (for example, when decryption of a picture is needed for display), the data encryption/decryption module 240 requests an application key corresponding to an application that generates the corresponding data from the application key generation module 230.

In operation 410, the application key generation module 230 receives a request for an application key from an authorized entity, that is, the data encryption/decryption module 240. In response to the request, the application key generation module 230 requests the application ID calculation module 220 to obtain an application ID. Accordingly, in operation 420, the application ID calculation module 220 calculates an application ID corresponding to the application that generates the data.

In response to the request for the application key, in operation 430, the application key generation module 230 requests the security key encryption module 210 to encrypt the security key 132a. Accordingly, the security key encryption module 210 encrypts the security key 132a and transfers the encrypted security key to the application key generation module 230. Accordingly, in operation 440, the application key generation module 230 receives the encrypted security key from the security key encryption module 210.

In operation 450, the application key generation module 230 generates an application key using the encrypted security key and the application ID.

In operation 460, the application key generation module 230 returns the application key to the authorized entity. The authorized entity encrypts data using the application key and stores the encrypted data in the normal area 131 or the secure area 132 of the storage unit 130. In addition, the authorized entity may decrypt ‘encrypted data’ read from the normal area 131 or the secure area 132 of the storage unit 130, using the application key. When returning of the application key is completed or when the application key is not used any longer since the use is completed in the authorized entity, the corresponding application key may be deleted from a memory, for example, an RAM.

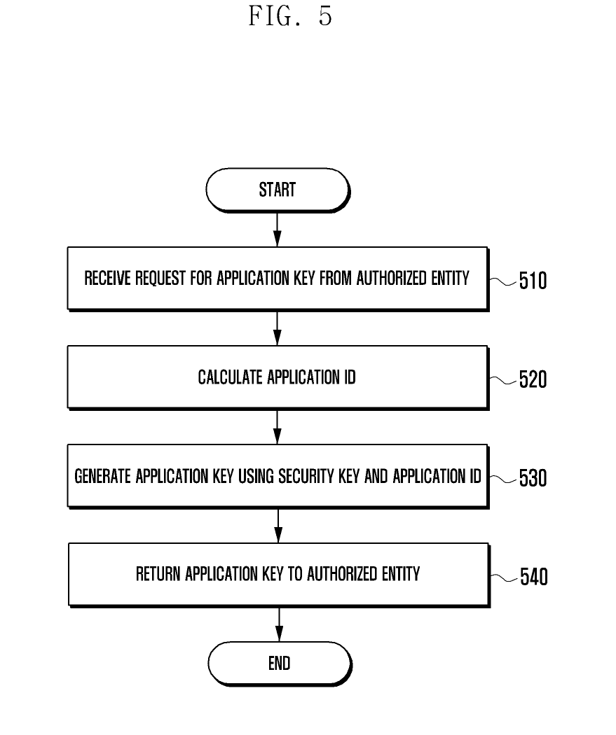

FIG. 5 is a flowchart illustrating a data security method according to an embodiment of the present disclosure.

Referring to FIGS. 1, 3, and 5, in operation 510, the application key generation module 320 receives a request for an application key from an authorized entity, that is, the data encryption/decryption module 330. In response to the request, the application key generation module 320 requests the application ID calculation module 310 to obtain an application ID. Accordingly, in operation 520, the application ID calculation module 310 calculates an application ID corresponding to an application that generates data, and transfers the calculated application key to the application key generation module 320.

When the application ID is received, in operation 530, the application key generation module 320 generates an application key using a security key and the application ID.

In operation 540, the application key generation module 320 returns the application key to the authorized entity.

According to various embodiments of the present disclosure as described above, there may be provided the following advantages.

Any value excluding a security key may not need to be additionally stored to generate an application key. Therefore, a storage space (for example, secure areas 132 and 161b) to be secured may be minimized and generation of a key may be possible for each application without a limit on a number of applications.

It is with a single security key that a plurality of application keys may be generated without a limit on a number of applications.

An application key is generated using a corresponding application ID and thus, may be unique for each application. In addition, the application key may be generated using a unique value (that is, a security key) of a corresponding device, and may be unique for each device. Therefore, it is significantly difficult to infer or hack an application key without an application ID, a security key, or information thereon. For example, a high-level hacking skill that is capable of accessing a secure area storing a security key may be needed.

Moreover, an application key according to the present disclosure may be generated without receiving any input from a user.

A seed value of an application key used for encrypting or decrypting data is stored in a secure area, and is different from a value that is generally stored in a normal area and is readily accessible (for example, an International Mobile Equipment Identity (IMEI)). Therefore, an operating system or applications in the normal area may not randomly access the secure area and thus, the seed value may be significantly secured.

Networking is not needed for generating an application key and help from another device is not needed. For example, an application key may be obtained by a corresponding device itself. Therefore, generation and the use of the application key may be efficient.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
receiving a request for an application key from a data generation application;
generating the application key using an application Identification (ID) corresponding to the data generation application and a security key stored in a secure area of the electronic device, in response to the request; and
encrypting data using the generated application key.

2. The method of claim 1, wherein the generating of the application key comprises:
encrypting the security key, and generating the application key using the encrypted security key and the application ID, in response to the request.

3. The method of claim 1, wherein the generating of the application key comprises:
calculating the application ID corresponding to the data generation application, in response to the request.

4. The method of claim 1, wherein the generating of the application key comprises:
generating the application key in the secure area.

5. The method of claim 1, wherein the encrypting of the data comprises:
encrypting the data in the secure area.

6. The method of claim 1, wherein the receiving of the request for the application key comprises:
receiving the request for the application key from a proxy application that executes encryption of data in place of the data generation application.

7. A method of operating an electronic device, the method comprising:
receiving a request for an encryption key or a decryption key from an application;
generating the encryption key or the decryption key using a security key stored in a secure area of the electronic device, in response to the request; and
transmitting the generated encryption key or decryption key to the application.

8. The method of claim 7, wherein the generating of the encryption key or the decryption key comprises:
generating the encryption key or the decryption key using the security key and an application Identification (ID) corresponding to a data generation application.

9. The method of claim 8, wherein the generating of the encryption key or the decryption key comprises:
encrypting the security key and generating an application key using the encrypted security key and the application ID, in response to the request.

10. An electronic device comprising:
a user input unit;
a memory comprising a normal area and a secure area; and
a processor configured to access the normal area to execute a program of the normal area, to access the secure area to execute a program of the secure area, and to connect the user input unit and the memory,
wherein the secure area comprises a key generation module configured to receive a request for an application key from an application, to generate the application key using an application Identification (ID) and a security key, in response to the request, and to transfer the generated application key to the application, and
wherein the security key is accessible in the secure area and inaccessible in the normal area.

11. The electronic device of claim 10, wherein the secure area comprises an encryption module configured to encrypt the security key, and to transfer the encrypted security key to the key generation module, in response to the request.

12. The electronic device of claim 10, wherein the secure area or the normal area comprises:
a calculation module configured to calculate an application ID corresponding to a data generation application, in response to the request.

13. The electronic device of claim 10, wherein the application corresponds to one of the components of the normal area or the secure area, and corresponds to a data generation application or a proxy application that executes encryption and decryption of data in place of the data generation application.

14. The electronic device of claim 10, wherein the user input unit comprises a touch screen.

15. An electronic device, comprising:
a user input unit;
a memory comprising a normal area and a secure area; and
a processor configured to access the normal area to execute a program of the normal area, to access the secure area to execute a program of the secure area, and to connect the user input unit and the memory,
wherein the secure area comprises a key generation module configured to receive a request for an encryption key or a decryption key from an application, to generate the encryption key or the decryption key using a security key in response to the request, and to transfer the generated encryption key or decryption key to the application, and
wherein the security key is accessible in the secure area and inaccessible in the normal area.

16. The electronic device of claim 15, wherein the key generation module is further configured to generate the encryption key or the decryption key using the security key and an application ID corresponding to a data generation application.

17. The electronic device of claim 15, wherein the secure area comprises:
an encryption module configured to encrypt the security key, and to transfer the encrypted security key to the key generation module, in response to the request.

18. The electronic device of claim 15, wherein the application corresponds to one of the components of the normal area or the secure area, and corresponds to a data generation application or a proxy application that executes encryption and decryption of data in place of the data generation application.

19. The electronic device of claim 15, wherein the user input unit comprises a touch screen.

20. A non-transitory computer-readable storage medium configured to store a computer program of instructions configured to be readable by at least one processor for instructing the at least one processor to execute a computer process for performing the method of claim 1.
